(19) United States
(12) Patent Application Publication
(10) Pub. No.: US 2022/0205290 A1
(43) Pub. Date: Jun. 30, 2022

(54) Structure for Operating Striker Capable of Being Fastened to Door Latch Part

(71) Applicants: Hyundai Motor Company, Seoul (KR); Kia Corporation, Seoul (KR)

(72) Inventors: Hyong-Don Kim, Yongin-si (KR); Chung-Sik Yim, Anyang-si (KR); Dae-Hee Lee, Incheon (KR); Yong-Hyun Nam, Anyang-si (KR); Kyu-Hoon Cho, Suwon-si (KR)

(21) Appl. No.: 17/459,773

(22) Filed: Aug. 27, 2021

(30) Foreign Application Priority Data
Dec. 30, 2020 (KR) 10-2020-0187707

(51) Int. Cl. E05B 85/26; E05B 79/20; E05B 53/00; E05B 83/40; E05B 81/14

(52) U.S. Cl. CPC E05B 85/26; E05B 79/20; E05B 81/14; E05B 83/40; E05B 53/003

(57) ABSTRACT

A structure includes a latch part to be mounted in a first door and a striker part to be mounted in a second door, the striker part including a housing, a movable unit to be connected to and movable in the housing, a striker mounted at one side of the movable unit and fixable by being caught by the latch part or releasable, and an operating unit for moving the movable unit, wherein the operating unit moves the movable unit in a direction in which the striker and the latch part become close to each other while the first and second doors are closed, and the operating unit moves the movable unit in a direction in which the striker and the latch part become distant from each other while the first and second doors are opened.

### CROSS-REFERENCE TO RELATED APPLICATIONS

This application claims the benefit of Korean Patent Application No. 10-2020-0187707, filed in the Korean Intellectual Property Office on Dec. 30, 2020, which application is hereby incorporated herein by reference.

### TECHNICAL FIELD

The present invention relates to a structure for operating a striker capable of being fastened to a door latch part.

### BACKGROUND

In general, a vehicle has an occupant compartment having a predetermined size in which a driver or an accompanied occupant may be seated, and occupant compartment opening/closing doors are installed on a vehicle body to open or close the occupant compartment.

The occupant compartment opening/closing doors includes a type of configuration in which a front door and a rear door are fastened or unfastened to be opened or closed. The types of doors include various types of doors such as opposite sliding doors, opposite swing doors, and mixed sliding and swing doors.

As an example of the occupant compartment opening/closing doors, FIG. IA illustrates the opposite sliding doors including a first door 10 and a second door 20 which operate to be opened or closed while taking postures opposite to each other. A B-pillar is removed for convenience for a user that enters and exits a vehicle.

As illustrated in FIG. 1B, in the related art, the occupant compartment opening/closing doors are opened or closed as a door latch 30 mounted in one (first door) of the occupant compartment opening/closing doors and a striker 40 mounted in the other (second door) of the occupant compartment opening/closing doors are fastened or unfastened.

However, because the door latch 30 and the striker 40 illustrated in FIG. 1B are mounted to protrude from the first and second doors 10 and 20, respectively, there is a problem in that a process of forming external appearances of door panels ii and 21 deteriorates.

Referring to FIGS. 2A and 2B, because trajectories of the door latch 30 and the striker 40 are different from each other when the doors in the closed state are opened, the door latch 30 and the striker 40 are abraded due to slip friction therebetween, which causes deterioration in durability. Specifically, frictional force F1 is generated between the latch claw lever 32 and the striker 40 due to a trajectory P1 of the latch claw lever 32 which constitutes the door latch 30 illustrated in FIG. 2A, and frictional force F2 is generated between the latch claw lever 32 and the striker 40 due to a trajectory P2 of the striker 40 illustrated in FIG. 2B. When the first door 10 and the second door 20 are simultaneously opened or closed, frictional forces F1 and F2 are generated to act in opposite directions, which causes abrasion of the door latch 30 and the striker 40.

Meanwhile, referring to FIG. 3, when the door latch 30 and the striker 40 are applied to the opposite swing doors as an example of the occupant compartment opening/closing doors, the striker 40 may be caught by a panel ii of the first door, which faces the striker 40, due to a trajectory P3 0f the striker 40 when the second door is opened first in the state in which the doors are closed. As a result, there is a problem in that the first door needs to be opened first before the second door is opened.

### SUMMARY

The present invention relates to a structure for operating a striker capable of being fastened to a door latch part. Particular embodiments relate to a structure for operating a striker, the structure being capable of easily opening and closing a door by moving the striker in one direction so that the striker is fastened to a latch part after the door is closed, and by moving the striker in the other direction so that the striker is released from the latch part before the door is opened.

Embodiments of the present invention provide a new type of structure in which a striker is received in a door when the door is opened, and the striker protrudes to the outside of the door only when the striker is intended to be fastened to the latch part in a state in which the door is closed, such that it is possible to improve a process of forming an external appearance of a panel while removing slip friction between the latch part and the striker.

An exemplary embodiment of the present invention provides a structure for operating a striker capable of being fastened to a door latch part, the structure including a latch part mounted in a first door, and a striker part mounted in a second door so as to be fastened to the latch part. The striker part includes a housing mounted on the second door, a movable unit connected to the housing so as to be movable in the housing, a striker mounted at one side of the movable unit and fixed by being caught by the latch part or released, and an operating unit configured to move the movable unit. The operating unit may move the movable unit in a direction in which the striker and the latch part become close to each other while the first and second doors are closed, and the operating unit may move the movable unit in a direction in which the striker and the latch part become distant from each other while the first and second doors are opened.

According to embodiments of the present invention, the following effects are achieved.

First, the latch parts and the striker parts are mounted in the first and second doors, respectively, and do not protrude to the outside of the doors, such that a process of forming an external appearance of a panel mounted on each of the doors does not deteriorate.

Second, there occurs no slip friction due to the trajectories of the latch part and the striker during the process of opening or closing the doors, and as a result, there occurs no problem of a deterioration in durability.

Third, there is no limitation that the direction in which the striker is fastened to the latch part needs to be perpendicular to the hinge shaft of the door.

### BRIEF DESCRIPTION OF THE DRAWINGS

FIG. 1A is a view illustrating opposite sliding doors, and FIG. 1B is a view illustrating a latch part mounted in a first door and a striker mounted in a second door in the related art.

FIG. 2A is a view illustrating a trajectory of a door latch mounted in the first door in the related art while the door is opened, and FIG. 2B is a view illustrating a trajectory of the striker mounted in the second door in the related art while the door is opened.

FIG. 3 is a view illustrating a relationship between a fastening direction of the striker and a hinge shaft of the door in the related art.

FIG. 4 is a view illustrating a state in which a striker according to an exemplary embodiment of the present invention moves while a door is closed.

FIG. 5 is a view illustrating a state in which the striker according to an exemplary embodiment of the present invention moves while the door is opened.

FIG. 6 is a view illustrating a movement connecting portion according to an exemplary embodiment of the present invention.

FIG. 7 is a view illustrating a state in which a movable unit according to an exemplary embodiment of the present invention has a guide protrusion.

FIG. 8 is a view illustrating a state in which a housing according to an exemplary embodiment of the present invention has a guide groove.

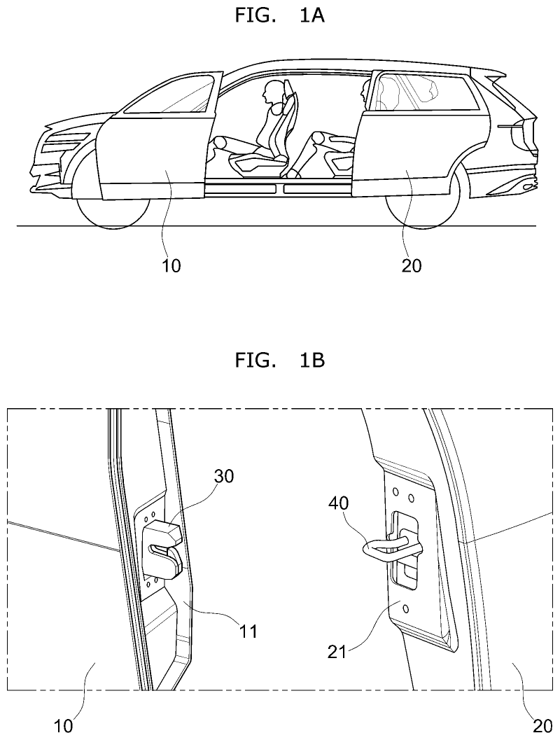

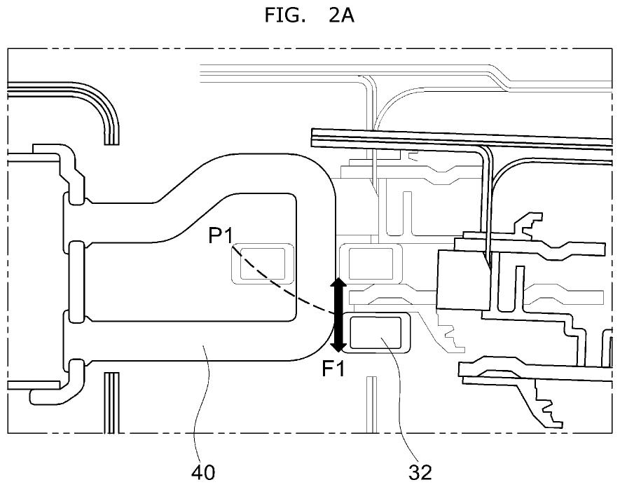

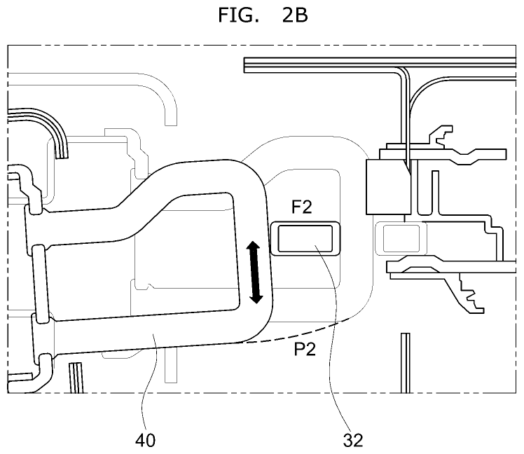

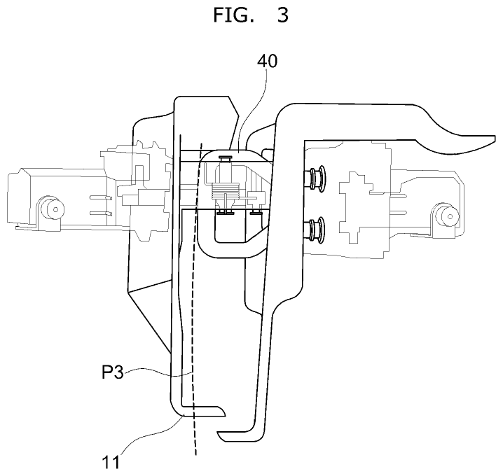

### DETAILED DESCRIPTION OF ILLUSTRATIVE EMBODIMENTS

Hereinafter, exemplary embodiments of a structure for operating a striker capable of being fastened to a door latch part will be described in detail with reference to the drawings. Terms or words used herein should not be interpreted as being limited to general or dictionary meanings and should be interpreted as meanings and concepts which conform to the technical spirit of the present invention based on a principle that an inventor can appropriately define a concept of a term in order to describe his/her own invention by the best method.

Embodiments of the present invention relate to a structure for moving a striker 230 to be fastened to a latch part 100 while a door is closed or opened. Embodiments of the present invention may be applied to vehicles having various types of doors, such as sliding doors, swing doors, and mixed sliding and swing doors.

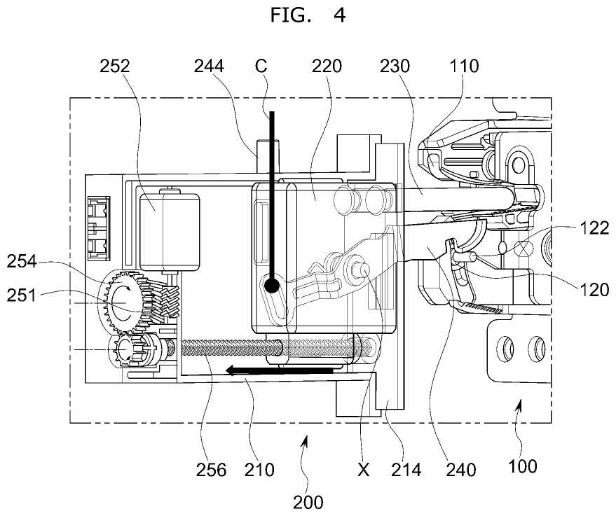

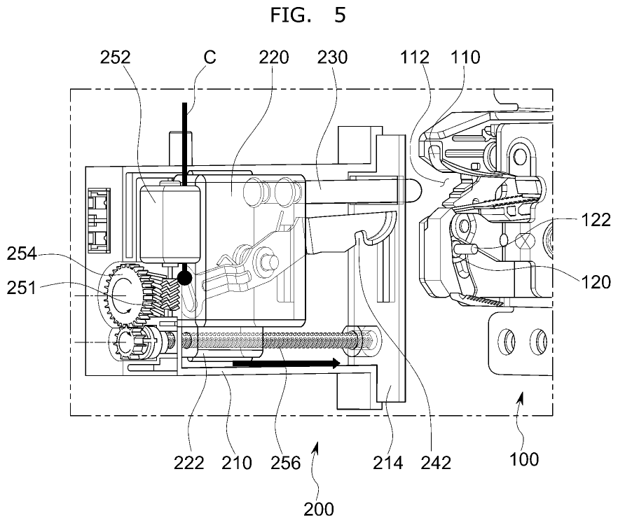

FIG. 4 is a view illustrating a state in which the striker according to an exemplary embodiment of the present invention moves while a door is closed, and FIG. 5 is a view illustrating a state in which the striker according to an exemplary embodiment of the present invention moves while the door is opened.

As illustrated in FIGS. 4 and 5, a structure for operating a striker capable of being fastened to a door latch part includes a latch part 100 mounted in a first door 10, and a striker part 200 mounted in a second door 20. In this case, any one of the first and second doors 10 and 20 is a front door, and the other of the first and second doors 10 and 20 is a rear door.

The latch part 100 includes a latch claw lever no. According to the exemplary embodiment of the present invention, the latch part 100 is mounted in the first door 10, and the latch part 100 does not protrude to the outside of the first door 10.

The latch claw lever no has an insertion groove 112 (see FIG. 5) into which the striker 230 may be inserted, and legs of the latch claw lever no are provided at both sides of the insertion groove 112. The latch claw lever 110 is rotatably connected to the first door 10.

A fixing lever 120 is provided at one side of the latch claw lever 110 and may rotate in conjunction with the latch claw lever no. The fixing lever 120 serves to maintain a posture of the latch claw lever no when the latch claw lever no is rotated and takes the posture at which the striker 230 may be caught. The fixing lever 120 also serves to maintain a posture of the latch claw lever no when the latch claw lever no is rotated and takes the posture at which the striker 230 cannot be caught. A fixing lever rotating unit 122 is provided at one side of the fixing lever 120 and may rotate the fixing lever 120.

The striker part 200 includes a housing 210, a movable unit 220, and an operating unit.

The housing 210 is fixedly mounted at one side of the second door 20 (a side directed toward the first door). The housing 210 has therein a space that may receive the movable unit 220 and the operating unit. An interface plate 214 is mounted at one side of the housing 210. Interfaces of the respective doors may face each other when the first door 10 and the second door 20 are closed, and in this case, the interface plate 214 may be disposed to be close to the interface of the second door 20. The interface plate 214 has a first hole through which the striker 300 may be extended or retracted, and a second hole through which a release lever 240 may be extended or retracted.

The movable unit 220 is connected to the housing 210 and may be moved in the housing 210. The movable unit 220 according to the exemplary embodiment of the present invention may have, but is not limited to, a casing shape having an internal space. The striker 230 is fixedly mounted on the movable unit 220, and the release lever 240 is rotatably mounted on the movable unit 220. Therefore, when the movable unit 220 moves, the striker 230 and the release lever 240 may also move.

The release lever 240 serves to assist in releasing the locking between the striker 230 and the latch part wo and may rotate about a rotary shaft X provided on the movable unit 220. A lever groove 242 into which the fixing lever rotating unit 122 may be inserted is provided at one end of the release lever 240, and a cable to be described below is connected to the other end of the release lever 240. Meanwhile, in the exemplary embodiment of the present invention, the portion of the release lever 240, which is in contact with the fixing lever rotating unit 122, has a groove shape, but may be variously formed. A return spring is provided on the rotary shaft X and provides rotational restoring force to the release lever 240.

A cable connecting portion 244 is provided on an upper portion of the movable unit 220 and the cable C may penetrate the cable connecting portion 244. One end of the cable C is connected to the release lever 240, and the other end of the cable C is connected to a component disposed outside the movable unit 220 through the cable connecting portion 244. When the cable C is pulled by external force, the release lever 240 may be rotated in one direction about the rotary shaft X. In contrast, when the external force is eliminated, the release lever 240 may be rotated in the other direction by the return spring.

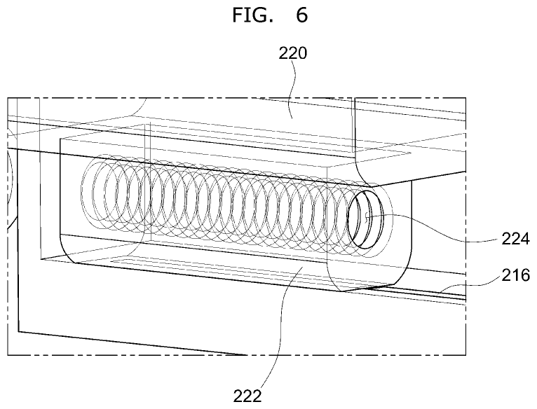

FIG. 6 is a view illustrating a movement connecting portion according to an exemplary embodiment of the present invention.

Referring to FIG. 6, a movement connecting portion 222 having a movement hole 224 is provided at one side of the movable unit 220, and a screw 256 to be described below may be penetratively inserted into the movement connecting portion 222. A screw thread is formed on an inner circumferential surface of the movement hole 224.

The operating unit is configured to move the movable unit 220 and includes a motor 252, a driven gear 254, and a screw 256.

The motor 252 provides driving power for moving the movable unit 220. A rotary pin is provided at one side of the motor 252, and a driving gear 251 is provided on an outer circumferential surface at one side of the rotary pin. In the exemplary embodiment of the present invention, the driving gear 251 serves as a worm gear.

The driven gear 254 is a gear for transmitting rotational force of the motor 252 to the screw 256 and takes a posture approximately perpendicular to the rotary pin of the motor 252. Gear teeth, which mesh with the driving gear 251, are formed on an outer circumferential surface at one side of the driven gear 254, and gear teeth, which mesh with the screw 256, are formed on an outer circumferential surface at the other side of the driven gear 254. In this case, an axial direction of the driven gear 254 and an axial direction of the screw 256 are provided in parallel with each other.

The screw 256 serves as a movement path of the movable unit 220, and a screw thread is formed on an outer circumferential surface of the screw 256. The screw thread formed on the outer circumferential surface of the screw 256 may mesh with the screw thread formed on the inner circumferential surface of the movement hole 224. Since the screw is connected to the motor 252 as described above, the screw 256 is rotated through the driven gear 254 when the motor 252 operates and rotates in a forward or reverse direction. In the exemplary embodiment of the present invention, one end of the screw 256 is connected to the housing 210, and the other end of the screw 256 is connected to the interface plate 214.

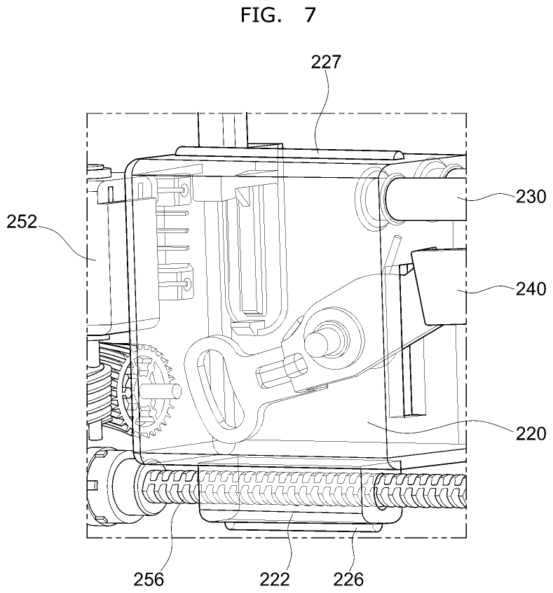

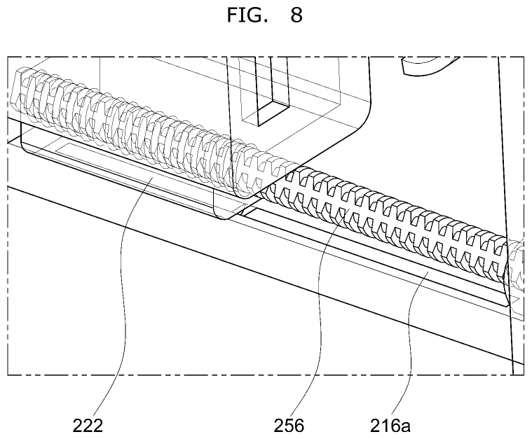

FIG. 7 is a view illustrating a state in which the movable unit according to an exemplary embodiment of the present invention has a guide protrusion, and FIG. 8 is a view illustrating a state in which the housing according to an exemplary embodiment of the present invention has a guide groove.

Meanwhile, an exemplary embodiment of the present invention further includes a structure for guiding the movement of the movable unit 220. Specifically, as illustrated in FIGS. 7 and 8, the movable unit 220 has guide protrusions 226a and 226b, and the housing 210 has a guide groove 216 into which the guide protrusion 226a may be inserted. In this case, the guide groove 216 is formed in the longitudinal direction of the screw 256 in the state in which the screw 256 is mounted in the housing 210. The guide groove 216 serves as a movement path of the movable unit 220. The guide groove 216 and the guide protrusion 226 prevent a sway of the movable unit 220 or guide an operation direction of the movable unit 220 while the movable unit 220 moves. In the exemplary embodiment of the present invention, the guide protrusions 226 and 227 are provided at both sides in an upward/downward direction of the movable unit 220, and the guide grooves are provided in the housing 210 so as to correspond to the guide protrusions 226 and 227. However, the number of guide protrusions 226 and 227 and the number of guide grooves are not limited, and the positions at which the guide protrusions 226 and 227 and the guide grooves are formed are not limited.

Hereinafter, a method of operating a structure for operating the striker capable of being fastened to the door latch part according to an exemplary embodiment of the present invention will be described. Specifically, the method of operating the striker 230 while performing a process of opening the doors 10 and 20 in the closed state will be described with reference to FIG. 4, and the method of operating the striker 230 while performing a process of closing the doors 10 and 20 in the opened state will be described with reference to FIG. 5.

FIG. 4 illustrates a state in which the striker 230 is operated when the doors 10 and 20 are closed. In the state in which the doors 10 and 20 are closed, the movable unit 220 is positioned in one direction (a right direction in FIG. 4), and the striker 230 protrudes to the outside of the housing 210. The striker 230 is caught by the latch claw lever no, and the latch claw lever no is fixed by the fixing lever 120, such that the state in which the striker 230 is caught is maintained.

Thereafter, when a user operates the doors 10 and 20 to open the doors 10 and 20, for example, when the user pushes an open button for the doors 10 and 20, the cable C and the operating unit are operated. Specifically, when the cable C is pulled, the release lever 240 is rotated and caught by the fixing lever rotating unit 122, and then the release lever 240 rotates the fixing lever 120. Then, the latch claw lever no is released, such that the latch claw lever no may be rotated, and the striker 230 may be released from the latch claw lever no. When the external force is eliminated after the cable C is pulled, the release lever 240 is returned to an original position by the return spring.

Thereafter, when the motor 252 of the operating unit rotates in the forward direction, the screw 256 rotates, and the movable unit 220 moves in the other direction (a left direction in FIG. 4) along the movement path of the screw 256. When the movable unit 220 reaches the other end of the screw 256, the operation of the motor 252 is stopped. In this case, the striker 230 is received in the housing 210, and the second door 20 does not protrude to the outside.

The process of operating the striker 230 during the operation of opening the door according to an exemplary embodiment of the present invention will be described. In the state in which the doors 10 and 20 are closed, the operation of opening the doors 10 and 20 is performed after the striker 230 is received in the housing 210.

FIG. 5 illustrates a state in which the striker 230 operates when the doors 10 and 20 are opened. In the state in which the doors 10 and 20 are opened, the movable unit 220 is positioned in the other direction (a left direction in FIG. 5), and the striker 230 is received in the housing 210 and does not protrude to the outside of the second door 20.

Thereafter, when the user operates the doors 10 and 20 to open the doors 10 and 20, for example, when the user pushes the close button for the doors 10 and 20, the doors 10 and 20 are closed. When the doors 10 and 20 are completely closed, the operating unit operates. Specifically, when the motor 252 of the operating unit rotates in the reverse direction, the screw 256 rotates, and the movable unit 220 moves in one direction (a right direction in FIG. 5) along the movement path of the screw 256. When the movable unit 220 reaches one end of the screw 256, the operation of the motor 252 is stopped. In this case, the striker 230 protrudes to the outside of the housing 210. In this case, the striker 230 is inserted into the insertion groove 112 of the latch claw lever no and then caught by the rotated latch claw lever no, and the striker 230 is fixed by the fixing lever 120.

The process of operating the striker 230 during the operation of closing the door according to an exemplary embodiment of the present invention will be described. In the state in which the doors 10 and 20 are closed, the striker 230 protrudes to the outside of the housing 210, such that the operation of closing the doors 10 and 20 is performed.

According to the exemplary embodiment of the present invention, the latch part 100 and the striker part 200 are mounted in the first and second doors 10 and 20, respectively. The latch part 100 and the striker part 200 are fastened to each other as the striker 230 protrudes after the doors 10 and 20 are closed. Therefore, since the latch part 100 and the striker part 200 do not protrude to the outside during the operation of opening or closing the doors 10 and 20, a process of forming external appearances of panels of the first and second doors 10 and 20 does not deteriorate.

In the related art, slip friction occurs between the latch part 100 and the striker 230 due to the trajectories of the latch part 100 and the striker 230 during the process of opening or closing the doors 10 and 20, which causes a problem with durability of the latch part 100 and the striker 230. However, in the exemplary embodiments of the present invention, there is little likelihood that slip friction occurs between the striker 230 and the latch part wo during the process of opening or closing the doors 10 and 20.

In the related art, the fastening direction of the striker 230 and the hinge shafts of the doors 10 and 20 needs to be perpendicular to each other. However, in the exemplary embodiments of the present invention, there is no such limitation.

The present invention has been described with reference to the limited exemplary embodiments and the drawings, but the present invention is not limited thereto. The described exemplary embodiments may be variously changed or modified by those skilled in the art to which the present invention pertains within the technical spirit of the present invention and within the scope equivalent to the appended claims.

What is claimed is:

1. A structure comprising:
a latch part configured to be mounted in a first door; and
a striker part configured to be mounted in a second door and configured to be fastened to the latch part, wherein the striker part comprises:
a housing configured to be mounted on the second door;
a movable unit configured to be connected to the housing so as to be movable in the housing;
a striker mounted at one side of the movable unit and configured to be fixed by being caught by the latch part or released; and
an operating unit configured to move the movable unit;
wherein the operating unit is configured to move the movable unit in a direction in which the striker and the latch part become close to each other while the first and second doors are closed; and
wherein the operating unit is configured to move the movable unit in a direction in which the striker and the latch part become distant from each other while the first and second doors are opened.

2. The structure of claim 1, further comprising a release lever rotatably connected to the movable unit, wherein the release lever is configured to assist in releasing the striker and the latch part.

3. The structure of claim 2, further comprising a cable connected to the release lever and configured to rotate the release lever.

4. The structure of claim 2, wherein:
the latch part comprises a fixing lever rotating unit configured to maintain constraint or release of the striker while rotating; and
the release lever comprises a catching portion configured to come into contact with the fixing lever rotating unit.

5. The structure of claim 1, wherein the housing has a guide path to guide a movement of the movable unit.

6. The structure of claim 5, wherein the housing comprises a guide groove and wherein the movable unit comprises a guide protrusion configured to be inserted into the guide groove.

7. The structure of claim 1, wherein the striker is configured to move to protrude to an outside of the housing while the first and second doors are closed.

8. The structure of claim 1, wherein the striker is configured to move to be received in the housing while the first and second doors are opened.

9. A structure comprising:
a latch part configured to be mounted in a first door; and
a striker part configured to be mounted in a second door and configured to be fastened to the latch part, wherein the striker part comprises:
a housing configured to be mounted on the second door;
a movable unit configured to be connected to the housing and be movable in the housing;
a striker mounted at one side of the movable unit and configured to be fixed by being caught by the latch part or released; and
an operating unit configured to move the movable unit, the operating unit comprising a motor and a screw connected to the motor and the movable unit, the screw being screw-coupled to the movable unit and configured to provide a path so that the movable unit is movable along with a rotation of the motor;
wherein the operating unit is configured to move the movable unit in a direction in which the striker and the latch part become close to each other while the first and second doors are closed; and
wherein the operating unit is configured to move the movable unit in a direction in which the striker and the latch part become distant from each other while the first and second doors are opened.

10. The structure of claim 9, wherein:
the movable unit comprises a movement connecting portion having a screw thread formed on an inner circumferential surface thereof; and
the screw is penetratively connected to the movement connecting portion.

11. The structure of claim 9, further comprising a driven gear configured to mesh with a driving gear of the motor, wherein gear teeth are formed at one end of the screw, the gear teeth being configured to mesh with the driven gear.

12. A vehicle comprising:
a vehicle body;
a first door coupled to the vehicle body;
a second door coupled to the vehicle body;
a latch part mounted in the first door; and
a striker part mounted in the second door and configured to be fastened to the latch part, wherein the striker part comprises:
a housing mounted on the second door;
a movable unit connected to the housing and configured to be movable in the housing;
a striker mounted at one side of the movable unit and configured to be fixed by being caught by the latch part or released; and
an operating unit configured to move the movable unit;
wherein the operating unit is configured to move the movable unit in a direction in which the striker and the latch part become close to each other while the first and second doors are closed; and
wherein the operating unit is configured to move the movable unit in a direction in which the striker and the latch part become distant from each other while the first and second doors are opened.

13. The vehicle of claim 12, further comprising a release lever rotatably connected to the movable unit, wherein the release lever is configured to assist in releasing the striker and the latch part.

14. The vehicle of claim 13, further comprising a cable connected to and configured to rotate the release lever.

15. The vehicle of claim 13, wherein:
the latch part comprises a fixing lever rotating unit configured to maintain constraint or release of the striker while rotating; and
the release lever comprises a catching portion configured to come into contact with the fixing lever rotating unit.

16. The vehicle of claim 12, wherein the housing comprises a guide path configured to guide a movement of the movable unit.

17. The vehicle of claim 16, wherein the housing comprises a guide groove, and wherein the movable unit comprises a guide protrusion configured to be inserted into the guide groove.

18. The vehicle of claim 12, wherein the striker is configured to move to protrude to an outside of the housing while the first and second doors are closed.

19. The vehicle of claim 12, wherein the striker is configured to move to be received in the housing while the first and second doors are opened.

20. The vehicle of claim 12, wherein the operating unit comprises:
a motor; and
a screw connected to the motor and the movable unit, screw-coupled to the movable unit, and configured to provide a path so that the movable unit is movable along with a rotation of the motor.
